(19) United States
(12) Patent Application Publication
(10) Pub. No.: US 2020/0215680 A1
(43) Pub. Date: Jul. 9, 2020

(54) BATTERY UNIT HAVING A LOCKING MECHANISM

(71) Applicant: Hilti Aktiengesellschaft, Schaan (LI)

(72) Inventors: Ralf MEIXNER, Germaringen (DE); Markus HOLUBARSCH, Landsberg am Lech (DE); Tobias KOENIGER, Bregenz (AT)

(21) Appl. No.: 16/631,228

(22) PCT Filed: Jul. 30, 2018
(86) PCT No.: PCT/EP2018/070535

§ 371 Date: Jan. 15, 2020

(30) Foreign Application Priority Data
Aug. 8, 2017 (EP) 17185222.1

(51) Int. Cl. B25F 5/02; H01M 2/10

(52) U.S. Cl. CPC B25F 5/02; H01M 2220/30; H01M 2/1022

(57) ABSTRACT

A battery unit (100), which is designed for being received in a receiving recess (90) of an electrical hand-held power tool (200). The battery unit (100) includes a locking mechanism (10), which in a locking state (VZ) prevents the battery unit (100) from being pulled out of the receiving recess (90), wherein the locking mechanism (10) has an unlocking button (11) with a pressing area (13), by pressing and deflecting which the locking mechanism (10) can be brought into a release state (FZ), in which the battery unit (100) can be pulled out of the receiving recess (90) in a pulling-out direction (AR), wherein the pressing area (13) defines in the release state (FZ) and in relation to the pulling-out direction (AR) a first oblique plane (E1) in such a way that a vector component (FA) of an actuating force (FB) acting on the pressing area (13) is oriented in the pulling-out direction (AR).

The present invention relates to a battery unit which is designed for being received in a receiving recess of an electrical hand-held power tool. The battery unit comprises a locking mechanism, which in a locking state prevents the battery unit from being pulled out of the receiving recess. The locking mechanism has an unlocking button with a pressing area, by pressing and deflecting which the locking mechanism can be brought into a release state. In the release state, the battery unit can be pulled out of the receiving recess in a pulling-out direction.

### BACKGROUND

Battery units of the type mentioned at the beginning are known in principle from the prior art.

### SUMMARY OF THE INVENTION

It is an object of the present invention to provide a battery unit that can be easily and ergonomically removed from a receiving recess of an electrical hand-held power tool.

The invention is achieved by the pressing area defining in the release state and in relation to the pulling-out direction a first oblique plane in such a way that a vector component of an actuating force acting on the pressing area is oriented in the pulling-out direction.

The invention includes the recognition that battery units of the prior art have to be mechanically unlocked in order to be able to remove them from a receiving recess of a hand-held power tool. This mechanical unlocking typically takes place by pressing at least one unlocking button or unlocking hook. Once the battery unit is unlocked, i.e. the locking mechanism is in the release state, the battery unit can be removed from the receiving recess by pulling or pressing in the pulling-out direction. It has been recognized in this connection that the expenditure of force required for this varies, depending on the wear, soiling and so on of the battery unit or the battery rails by which the battery unit can be held in the receiving recess.

In the case of battery units of the prior art, the removal of the battery unit is made more difficult from an ergonomic viewpoint by the actuating force for actuating the unlocking mechanism having to be applied in an orientation transverse or even counter to the pulling-out direction. In other words, it has been recognized that it is problematic in the case of battery units of the prior art that, when for example the locking mechanism is pressed with the thumb in one direction, the battery itself however then has to be pulled out of the receiving recess in the opposite direction. Simultaneously pressing the locking button in one direction and pulling out the battery unit in the other direction (pulling-out direction) is problematic from an ergonomic viewpoint.

These disadvantages are avoided, or at least reduced, by the battery unit according to the invention. The removal of the battery unit is made significantly easier by the fact that a vector component of an actuating force acting on the pressing area is oriented in the pulling-out direction.

In a preferred refinement, it is provided that the pressing area defines in the locking state and in relation to the pulling-out direction a second oblique plane in such a way that the vector component of the actuating force acting on the pressing area is oriented counter to the pulling-out direction.

It has been found to be advantageous if the locking mechanism is mounted on the battery unit rotatably about an axis of rotation running perpendicularly to the pulling-out direction. The locking mechanism may be rotatably mounted on the battery unit by means of a rotary joint. Alternatively, the locking mechanism may be rotatably mounted on the battery unit by means of a compliant mechanism.

Preferably formed on a surface of the battery unit is a clearance into which the locking mechanism can pivot in the course of its actuation in the direction of the release state. By pivoting the locking mechanism or the unlocking button with its pressing area comparatively far in, a vector component of the actuating force acting on the pressing area that is oriented in the pulling-out direction can be advantageously increased.

It has been found to be advantageous that, in the release state, an adjacent angle that is formed between the first oblique plane and the pulling-out direction and is defined about the axis of rotation is between 5 degrees and 10 degrees. The adjacent angle may be between 5 and 20 degrees.

In a further preferred refinement, the locking mechanism comprises a latching hook, which in the locking state is in engagement with a corresponding latching clearance formed on the receiving recess. Preferably just one latching hook is provided.

It has been found to be advantageous if the pulling-out direction runs parallel to the axis of rotation of a tool spindle of the power tool.

Preferably, the locking mechanism is provided in addition to a battery rail which is provided on the battery unit and serves for holding the battery unit on the hand-held power tool.

In a further preferred refinement, the locking mechanism is arranged exclusively on a side of the battery unit that is facing the hand-held power tool for operating purposes.

It has been found to be advantageous if the actuating force is to be applied predominantly perpendicularly to the pulling-out direction and parallel to a handle of the hand-held power tool.

The invention is likewise achieved by an electrical hand-held power tool having a battery unit as described above.

Further advantages can be found in the description of the figures that follows. The figures depict various exemplary embodiments of the present invention. The figures, the description and the claims contain numerous features in combination. A person skilled in the art will expediently also consider the features individually and combine them to produce useful further combinations.

### BRIEF DESCRIPTION OF THE DRAWINGS

In the figures, identical and similar components are denoted by the same reference signs. In the figures:

FIG. 1 shows a preferred exemplary embodiment of a battery unit according to the invention, which is arranged on an electrical hand-held power tool;

FIGS. 2A and 2B show a preferred exemplary embodiment of a locking mechanism according to the invention in the release state and in the locking state;

FIG. 3 shows the locking mechanism from FIG. 2B in the release state; and

FIG. 4 shows a perspective view of a preferred exemplary embodiment of a battery unit according to the invention.

### DETAILED DESCRIPTION

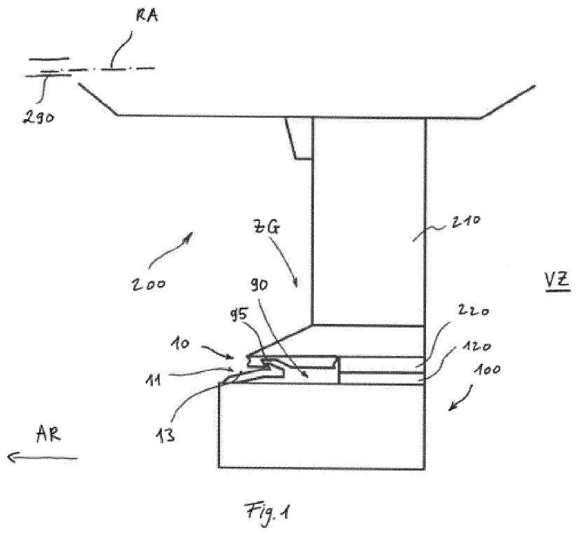

A battery unit 100 and an electrical hand-held power tool 200 are represented in FIG. 1. The battery unit 100 is designed for being received in a receiving recess 90 of the hand-held power tool 200. For this purpose, the battery 100 comprises a battery rail 120, which is in interlocking engagement with a device rail 220 formed on the hand-held power tool 200. The battery rail 120 and the device rail 220 prevent the battery unit 100 from falling out of the receiving recess 90 (vertically downward in FIG. 1).

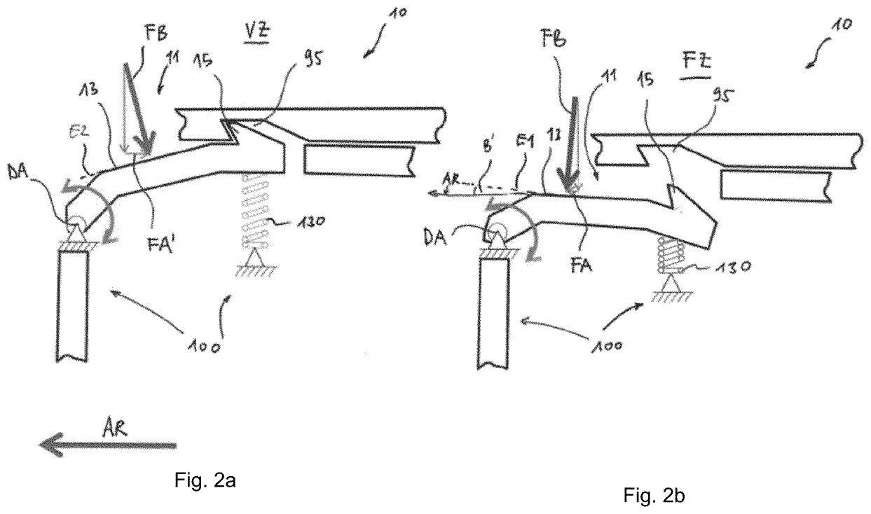

The battery unit 100 also comprises a locking mechanism 10, which in the locking state VZ shown here prevents the battery unit 100 from being pulled out in the pulling-out direction AR. The locking mechanism 10 has an unlocking button 11 with a pressing area 13. By pressing the pressing area 13, and accordingly deflecting the unlocking button 11, the unlocking mechanism 10 can be brought into a release state (cf. FIG. 2B), in which the battery unit 100 can be pulled out of the receiving recess 90 in the pulling-out direction AR.

As FIG. 1 likewise reveals, the pulling-out direction AR runs parallel to the axis of rotation RA of a tool spindle 290 of the hand-held power tool 200. Furthermore, the locking mechanism 10 is arranged exclusively on a side ZG of the battery unit 100 that is facing the hand-held power tool 200 for operating purposes. For operating purposes should be understood here as meaning that the battery unit 100 is arranged in the receiving recess 90 so as to supply the electrical hand-held power tool 200 with power.

As FIG. 1 likewise reveals, the locking mechanism 10 comprises a latching hook 15, which in the locking state VZ shown is in engagement with a corresponding latching clearance 95 formed on the receiving recess 90. The engagement of the latching hook 15 in the latching clearance 95 has the effect of preventing the battery unit 100 from being pulled out of the receiving recess 90.

The actual locking mechanism according to the invention is now described with reference to FIGS. 2A and 2B.

For this purpose, FIG. 2A first shows the locking state VZ, in which the latching hook 15 is hooked in the corresponding latching clearance 95, and consequently the battery unit 100 is prevented from being pulled out in the pulling-out direction AR. FIG. 2B, on the other hand, shows the release state FZ, in which the latching hook 15 is not in engagement with the latching clearance 95, and accordingly the battery unit 100 can be pulled out of the receiving recess 90, which is not shown any more specifically here, in the pulling-out direction AR.

According to the invention, it is provided (see FIG. 2B) that the pressing area 13 defines in the release state FZ and in relation to the pulling-out direction AR a first oblique plane E1 in such a way that a vector component FA of an actuating force FB acting on the pressing area 13 is oriented in the pulling-out direction AR.

In order therefore to bring the unlocking mechanism 10 into the release state FZ shown in FIG. 2B, the user must for example apply an actuating force FB with the thumb to the pressing area 13. As a result of the inclination of the pressing area 13 in relation to the pulling-out direction AR (horizontal) that is shown in FIG. 2B, a vector component FA of the actuating force FB acts in the pulling-out direction. In other words, the actuating force FB that is required in any case for unlocking the locking mechanism 10 assists pulling out of the battery unit 100 in the pulling-out direction AR. The absolute amount of the vector component FA is determined here by the cosine of the angle B, formed between the pulling-out direction AR and the first oblique plane E1, multiplied by the actuating force FB acting on the pressing area 13.

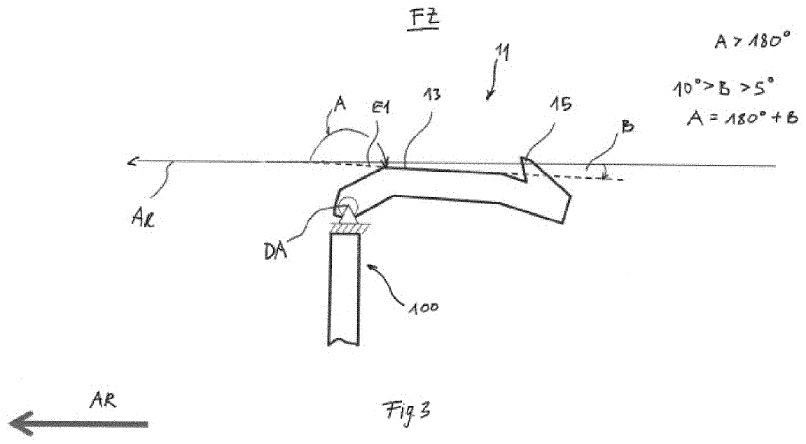

This will be further explained later with reference to FIG. 3.

As FIG. 2B likewise reveals, the actuating force FB is to be applied counter to a compression spring 130.

FIG. 2A then shows the locking state VZ. The locking mechanism 10 is designed in such a way that the pressing area 13 defines in the locking state VZ and in relation to the pulling-out direction AR a second oblique plane E2 in such a way that the vector component FA′ of the actuating force FB acting on the pressing area 13 is oriented counter to the pulling-out direction AR. The fact that the vector component FA′ is oriented counter to the pulling-out direction AR means that, when the actuating force FB is applied, initially an unlatching of the latching hook 15 from the corresponding latching clearance 95 is assisted. By further pressing on the pressing area 13, the unlocking button 11 is brought into the state shown in FIG. 2B, in which, as already described, the vector component FA is is oriented in the pulling-out direction AR.

The locking mechanism 10 is mounted on the battery unit 100 rotatably about an axis of rotation DA running perpendicularly to the pulling-out direction AR. In FIGS. 2A and 2B, the axis of rotation DA extends into the plane of the image.

It is clear from joint consideration of FIGS. 1, 2A and 2B that the actuating force FB is to be applied predominantly perpendicularly to the pulling-out direction AR and parallel to the handle 210 of the hand-held power tool 200 (cf. FIG. 1).

In other words, the absolute amount of the vector component FA is less than half, preferably less than a third, of the absolute amount of the actuating force FB.

The angular relationships of the first oblique plane E1 provided according to the invention are now to be described more specifically with reference to FIG. 3.

For the purposes of the description, in FIG. 3 the pulling-out direction AR coincides with the horizontal. On the basis of the pulling-out direction AR, a main angle A is defined in the clockwise direction around the axis of rotation DA and, in the release state FZ shown here, is greater than 180°. An adjacent angle B is defined between the pulling-out direction AR and the first oblique plane E1 in the clockwise direction around the axis of rotation DA.

Preferably, in the release state FZ, an adjacent angle B of between 5° and 10° is provided. However, to produce a vector component FA oriented in the pulling-out direction AR, it is required that the adjacent angle B is greater than 0°. The absolute amount of the vector component FA oriented in the pulling-out direction AR increases as the adjacent angle B increases. The adjacent angle B represented in FIG. 3 corresponds to the angle B′ represented in FIG. 2B.

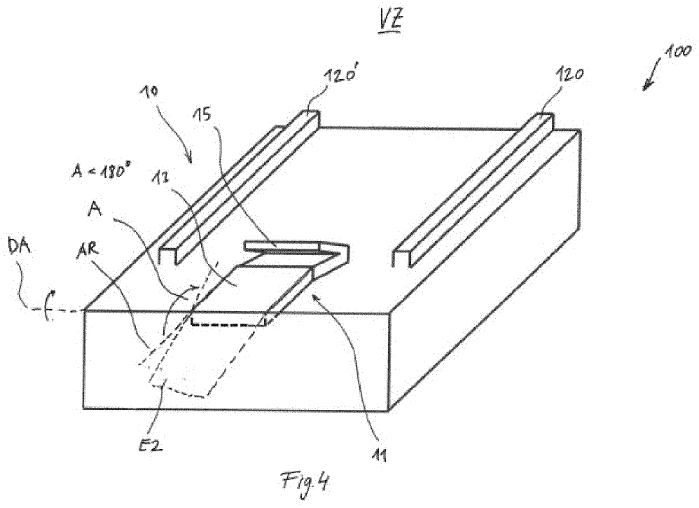

FIG. 4 finally shows a perspective representation of the battery unit 100 according to the invention. The battery rails 120, 120′ arranged on both sides of the battery unit 100, which interact with corresponding device rails 220 (cf. FIG. 1) for holding the battery unit 100 in the receiving recess, can be seen well.

In FIG. 4, the battery unit 100 is not in the receiving recess 90. Since, however, no actuating force is acting on the pressing area 13, the locking mechanism 10 is in the position that it would also assume in the locking state VZ (cf. FIG. 1 and FIG. 2A). Accordingly, the pressing area 13 also defines a second oblique plane E2, where, by contrast with FIG. 3, the main angle A is less than 180°. Accordingly, an actuating force FB applied to the pressing area 13 would also bring about a vector component FA′ (cf. FIG. 2A) that is oriented counter to the pulling-out direction AR.

### LIST OF REFERENCE SIGNS

10 Locking mechanism
11 Unlocking button
13 Pressing area
15 Latching hook
90 Receiving recess
95 Corresponding latching clearance
100 Battery unit
120, 120 Battery rail
130 Compression spring
200 Hand-held power tool
210 Handle
220 Device rail
290 Tool spindle
AR Pulling-out direction of the battery
A Main angle
B, Adjacent angle
DA Axis of rotation
E1 First oblique plane
E2 Second oblique plane
FA Vector component of the actuating force
FB Actuating force
FZ Release state
RA Axis of rotation of the tool spindle
VZ Locking state
ZG Facing side

What is claimed is:

1-10. (canceled)

11. A battery unit for being received in a receiving recess of an electrical hand-held power tool, the battery unit comprising:
a locking mechanism, the locking mechanism in a locking state preventing the battery unit from being pulled out of the receiving recess, the locking mechanism having an unlocking button with a pressing area, by pressing and deflecting the pressing area the locking mechanism bringable into a release state, the battery unit pullable out of the receiving recess (90) in a pulling-out direction in the release state,
the pressing area defining in the release state and in relation to the pulling-out direction a first oblique plane in such a way that a vector component of an actuating force acting on the pressing area is oriented in the pulling-out direction.

12. The battery unit as recited in claim 11 wherein the pressing area defines in the locking state and in relation to the pulling-out direction a second oblique plane in such a way that the vector component of the actuating force acting on the pressing area is oriented counter to the pulling-out direction.

13. The battery unit as recited in claim 11 wherein the locking mechanism is mounted on the battery unit rotatably about an axis of rotation running perpendicularly to the pulling-out direction.

14. The battery unit as recited in claim 13 wherein, in the release state, an adjacent angle is formed between the first oblique plane and the pulling-out direction and is between about 5 and 10 degrees about the axis of rotation.

15. The battery unit as recited in claim 11 wherein the locking mechanism includes a latching hook, the latching hook in the locking state being in engagement with a corresponding latching clearance formed on the receiving recess.

16. The battery unit as recited in claim 11 wherein the pulling-out direction runs parallel to the axis of rotation of a tool spindle of the hand-held power tool.

17. The battery unit as recited in claim 11 wherein the locking mechanism is provided in addition to a battery rail formed on the battery unit.

18. The battery unit as recited in claim 11 wherein the locking mechanism is arranged exclusively on a side of the battery unit facing the hand-held power tool for operating purposes.

19. The battery unit as recited in claim 11 wherein the actuating force is to be applied perpendicularly to the pulling-out direction and parallel to a handle of the hand-held power tool.

20. An electrical hand-held power tool comprising the battery unit as recited in claim 11.
